(19) United States
(12) Patent Application Publication
(10) Pub. No.: US 2019/0236961 A1
(43) Pub. Date: Aug. 1, 2019

(54) INFORMATION SYSTEM, INFORMATION PROCESSING METHOD, AND COMPUTER-READABLE NON-TRANSITORY STORAGE MEDIUM RECORDING PROGRAM

(71) Applicant: Toyota Jidosha Kabushiki Kaisha, Toyota-shi Aichi-ken (JP)

(72) Inventors: Yusuke Kaneko, Nagoya-shi Aichi-ken (JP); Masato Endo, Nagakute-shi Aichi-ken (JP); Shinji Sassa, Ama-shi Aichi-ken (JP); Takahiro Shiga, Chiryu-shi Aichi-ken (JP); Yohei Tanigawa, Toyota-shi Aichi-ken (JP)

(73) Assignee: Toyota Jidosha Kabushiki Kaisha, Toyota-shi Aichi-ken (JP)

(21) Appl. No.: 16/260,509

(22) Filed: Jan. 29, 2019

(30) Foreign Application Priority Data
Jan. 30, 2018 (JP) 2018-013957

(51) Int. Cl. G08G 1/00; G06Q 10/08; G06Q 20/20; G06F 1/3203

(52) U.S. Cl. CPC G08G 1/22; G06Q 10/087; G08G 1/205; G06F 1/3203; G06Q 10/08355; G06Q 20/203; G06Q 10/0833

(57) ABSTRACT

An information system includes circuitry configured to: detect, from a store moving body configured to function as a store among a plurality of moving bodies, a shortage of a stock situation of a replenishment target that is supplied to the store moving body; select a replenishment moving body being able to supply the replenishment target to the store moving body from among the moving bodies; and instruct the selected replenishment moving body to supply the replenishment target to the store moving body when the shortage of the stock situation of the replenishment target at the store moving body is detected.

### CROSS-REFERENCE TO RELATED APPLICATION

This application claims priority to Japanese Patent Application No. 2018-013957 filed on Jan. 30, 2018, incorporated herein by reference in its entirety.

### BACKGROUND

### 1. Technical Field

The present disclosure relates to an information system, an information processing method, and a computer-readable non-transitory storage medium recording a program.

### 2. Description of Related Art

In the related art, a moving body such as a vehicle is used for a user to move to a desired destination or to transport a package to a desired delivery destination in many cases. Various technologies regarding mobility-as-a-service (MaaS) that provide mobility of a person or an object as a service using a moving body performing autonomous traveling have been proposed. For example, Japanese Patent No. 6164599 (JP 6164599 B) proposes a system in which a package is transported to a predetermined home delivery box through autonomous driving and is stored in the home delivery box without via hands of a person.

### SUMMARY

Incidentally, in a concept of the above-described MaaS, an aspect in which a space inside the vehicle is used for not only movement of a person or an object but also a store providing product sales or a labor service is considered. When a moving body such as a vehicle is caused to function as a store, continuously providing a product or labor service in consideration of use of unspecified users as well as reserved users may be performed, unlike delivery of packages.

The present disclosure provides a technology capable of ensuring continuity of a service that is provided by a moving body that functions in a multipurpose manner.

A first aspect of the disclosure provides an information system including circuitry configured to: detect, from a store moving body configured to function as a store among a plurality of moving bodies, a shortage of a stock situation of a replenishment target that is supplied to the store moving body; select a replenishment moving body being able to supply the replenishment target to the store moving body from among the moving bodies; and instruct the selected replenishment moving body to supply the replenishment target to the store moving body when the shortage of the stock situation of the replenishment target at the store moving body is detected.

According to the first aspect of the present disclosure, since the replenishment moving body can replenish the store moving body in which shortage of the stock situation of the product has occurred, with products being short, it is possible to suppress occurrence of shortage of products and the like as much as possible. According to the first aspect of the present disclosure, it is possible to ensure the continuity of the service that is provided by the store moving body.

In the first aspect, the replenishment moving body may be at least one of the other store moving body among the moving bodies and a dedicated moving body, the dedicated moving body being configured to function for a purpose of replenishment of the replenishment target for which the shortage of the stock situation is detected.

According to the above configuration, it is possible to perform rapid replenishment to the store moving body in which shortage of a stock situation of the product has occurred.

In the first aspect, the information system may further include a communication unit configured to communicate with the store moving body via a network. The circuitry may be configured to receive at least one of information from a point of sales terminal acquired at the store moving body, tag information imparted to the replenishment target, information from a sensor that detects an amount of consumption of the replenishment target, and information from a sensor that detects a remaining amount of the replenishment target via the communication unit, and detect the shortage of the stock situation.

In the first aspect, the replenishment target may be an expendable product constituting the store moving body; and the circuitry may be configured to manage a use period of the expendable product and instruct the replenishment moving body to supply the expendable product to the store moving body when the use period of the expendable product exceeds a first threshold value.

According to the above configuration, since an expendable product of which the use period exceeds the predetermined period can be replenished, it is possible to suppress service stop due to failure of the expendable product in advance.

In the first aspect, the replenishment target may act as a supply unit configured to supply energy for causing the store moving body to function and the circuitry may be configured to manage a saving state of the energy for causing the store moving body to function, and instruct the replenishment moving body to replenish the store moving body with the energy via the replenishment target acting as the supply unit when the saving state of the energy falls below a second threshold value needed for causing the store moving body to function.

According to the aspect of the present disclosure, since the replenishment moving body can replenish energy to the store moving body of which the energy state is determined to be below the predetermined amount, it is possible to suppress service stop due to exhaustion of the energy in advance.

In the first aspect, the circuitry may be configured to acquire positional information of the moving bodies; and the circuitry may be configured to select the replenishment moving body instructed to supply the replenishment target based on positional information of the store moving body and the replenishment moving body.

According to the above configuration, since another store moving body close to the store moving body needing replenishment can replenish the store moving body with replenishment targets, it is possible to maintain the continuity of service.

In the first aspect, the circuitry may be configured to determine a joining point of the store moving body and the replenishment moving body from any one of a point on a moving route of the store moving body or the replenishment moving body, and a point at which parking and stopping are possible within a region in which the store moving body provides a product sales or a service, with positions at a current point in time of the store moving body and the replenishment moving body being respective departure places.

A second aspect of the disclosure provides an information processing method executable by a computer. The information processing method includes: (a) detecting, from a store moving body configured to function as a store among a plurality of moving bodies, a shortage of a stock situation of a replenishment target that is supplied to the store moving body; (b) selecting, from among the moving bodies, a replenishment moving body being able to supply the replenishment target to the store moving body; and (c) instructing the selected replenishment moving body to supply the replenishment target to the store moving body when the shortage of the stock situation of the replenishment target at the store moving body is detected.

In the second aspect, the replenishment moving body may be at least one of the other store moving body among the moving bodies and a dedicated moving body, the dedicated moving body being configured to function for a purpose of replenishment of the replenishment target for which the shortage of the stock situation is detected.

In the second aspect, the step of (a) may include receiving at least one of information from a point of sales terminal acquired at the store moving body, tag information imparted to the replenishment target, information from a sensor that detects an amount of consumption of the replenishment target, and information from a sensor that detects a remaining amount of the replenishment target, and detecting the shortage of the replenishment target to be supplied to the store moving body.

In the second aspect, the replenishment target may be an expendable product constituting the store moving body; and the step of (c) may include managing a use period of the expendable product and instructing the replenishment moving body to supply the expendable product to the store moving body when the use period of the expendable product exceeds a first threshold value.

In the second aspect, the replenishment target may act as a supply unit configured to supply energy for causing the store moving body to function; and the step of (c) may include managing a saving state of the energy for causing the store moving body to function, and instructing the replenishment moving body to supply the energy to the store moving body via the replenishment target acting as the supply unit, when the saving state of the energy falls below a second threshold value needed for causing the store moving body to function.

The information processing method according to the second aspect may further include (d) acquiring positional information of the moving bodies, and the step of (b) may include selecting a replenishment moving body instructed to supply the replenishment target based on the positional information of the store moving body and the replenishment moving body.

The information processing method according to the second aspect may further include (e) determining a joining point of the store moving body and the replenishment moving body from any one of a point on a moving route of the store moving body or the replenishment moving body, and a point at which parking and stopping are possible within a region in which the store moving body provides a product sales or a service, with positions at a current point in time of the store moving body and the replenishment moving body being respective departure places.

A third aspect of the disclosure provides a non-transitory storage medium recording a program. The program causes a computer to execute: detecting, from a store moving body configured to function as a store among a plurality of moving bodies, a shortage of a stock situation of a replenishment target that is supplied to the store moving body; selecting a replenishment moving body being able to supply the replenishment target to the store moving body from among the moving bodies; and instructing the selected replenishment moving body to supply the replenishment target to the store moving body when the shortage of the stock situation of the replenishment target at the store moving body is detected.

According to the above aspects of the present disclosure, it is possible to provide a technology capable of ensuring the continuity of a service that is provided by a moving body having a multipurpose function.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a schematic configuration of a moving body system to which a replenishment management system according to an embodiment is applied;

FIG. 2 is a block diagram illustrating a schematic configuration of a vehicle, a center server, and a replenishment management server;

FIG. 3 is a table illustrating vehicle management information;

FIG. 4 is a table illustrating vehicle stock management information;

FIG. 5 is a table illustrating product management information;

FIG. 6 is a table illustrating replenishment vehicle management information;

FIG. 7 is a table illustrating expendable product management information;

FIG. 8 is a flowchart illustrating an example of a replenishment instruction generation process in which a product or the like that is provided by a store vehicle is a replenishment target;

FIG. 9 is a flowchart illustrating an example of a replenishment instruction generation process in which an expendable product constituting a store vehicle is a replenishment target; and

FIG. 10 is a flowchart illustrating an example of a replenishment instruction generation process in which energy for driving a store vehicle is a replenishment target.

### DETAILED DESCRIPTION

Hereinafter, a replenishment management system according to an embodiment will be described with reference to the drawings. A configuration of the following embodiment is an example, and this replenishment management system is not limited to the configuration of the embodiment.

1. System Configuration

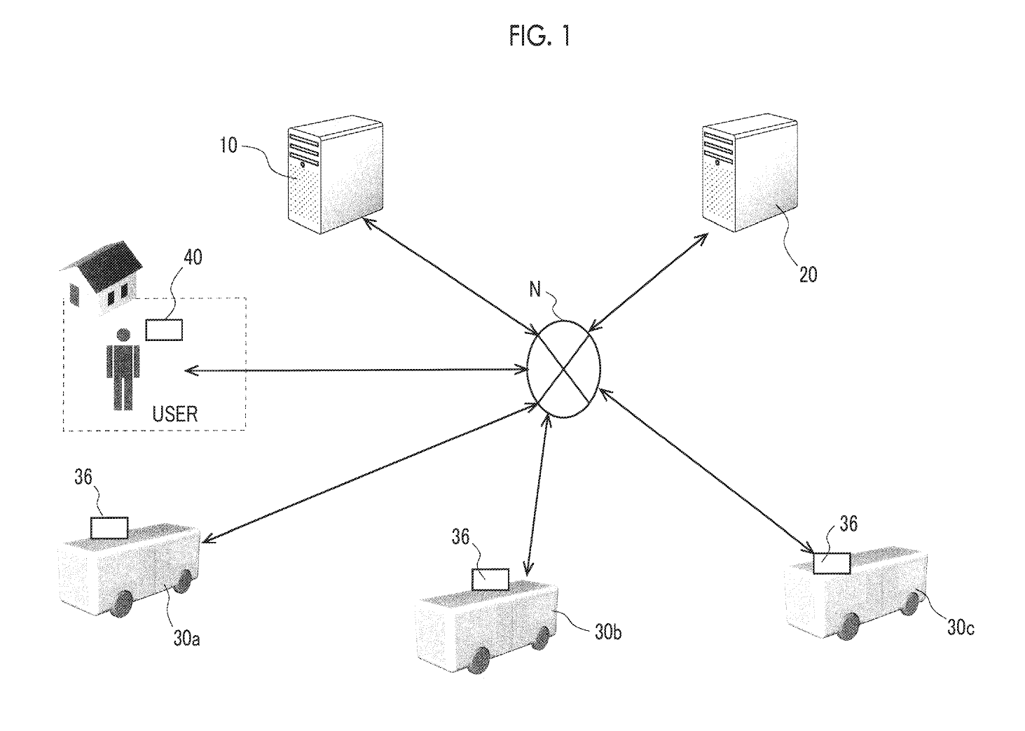

FIG. 1 is a diagram illustrating a schematic configuration of a moving body system to which a replenishment management system according to an embodiment is applied. The replenishment management system 1 according to the embodiment functions as a part of a moving body system or a complementary system that cooperates with the moving body system. First, an overview of the moving body system will be described. The moving body system includes a plurality of autonomous traveling vehicles 30a, 30b, 30c that perform autonomous traveling based on a given command, and a center server 10 that issues the command. Hereinafter, the autonomous traveling vehicle is simply referred to as a “vehicle”, and the autonomous traveling vehicles 30a, 30b, 30c are collectively referred to as a “vehicle 30”.

The vehicle 30 is an autonomous drive vehicle that provides a predetermined mobility service according to various needs of users and is a vehicle capable of autonomously travel on a road. An example of a vehicle capable of autonomous traveling constituting a moving body system includes a self-propelled electric vehicle called an electric vehicle (EV) pallet. The vehicle 30 is a multipurpose moving body capable of changing the exterior or interior of the subject vehicle and optionally selecting a vehicle size according to a use or purpose of a mobility service to be provided. The vehicle 30 provides a predetermined mobility service such as movement of a user, transport of packages, and sales of products to users according to a need of a user who has been via the user terminal 40 or any user. Further, the center server 10 is a device that manages a plurality of vehicles 30 constituting a moving body system, and issues an operation command to each vehicle 30. The user terminal 40 illustrated in FIG. 1 is, for example, a small computer such as a smartphone, a mobile phone, a tablet terminal, a personal digital assistant, or a wearable computer (a smart watch or the like). However, the user terminal 40 may be a personal computer (PC) that is connected to the center server 10 via a network N. The vehicle 30 is an example of a “moving body”.

In the moving body system illustrated in FIG. 1, the center server 10, the vehicle 30, and the user terminal 40 are mutually connected via a network N. Further, a replenishment management server 20 constituting the replenishment management system 1 of the embodiment is connected to the network N. The network N includes a public network such as the Internet, a wireless network such as a mobile phone network, a dedicated network such as a virtual private network (VPN), and a network such as a local area network (LAN). A plurality of other center servers 10, vehicles 30, user terminals 40, and replenishment management servers 20 (not illustrated) can be connected to the network N.

In a moving body system to which the replenishment management system 1 according to the embodiment is applied, the vehicles 30a, 30b function, for example, as movement type stores (hereinafter, a vehicle 30 functioning as a store is simply referred to as “a store vehicle 30”) intended for provision of product sales or labor service to users. The store vehicle 30 provides product sales or labor service that is handled as a store while moving within a predetermined region determined in advance. A moving route within the predetermined region of the store vehicle 30 may be determined appropriately on the moving body system side according to a season, weather, and traffic situation, and may move on a road around a user according to a request from the user. A replenishment management terminal 36 is mounted in the store vehicle 30 to which replenishment management of the replenishment management system 1 according to the embodiment is applied, as will be described below. Other configurations of the store vehicle 30 are not limited to specific ones as long as the replenishment management terminal 36 is mounted. Further, the store vehicle 30 does not necessarily need to be unmanned. For example, sales personnel, customer reception personnel, security personnel, or the like who provides the product sales or labor service that is handled by the store vehicle 30 to a user who uses the service may get on the store vehicle 30. In addition, the store vehicle 30 may not necessarily be a vehicle that performs autonomous traveling always. For example, the store vehicle 30 may be a vehicle on which the person performs driving or assistance in driving according to situations. In FIG. 1, two store vehicles (vehicles 30a, 30b) are illustrated, but the moving body system includes a plurality of store vehicles 30. The store vehicle 30 is an example of a “store moving body”.

Further, the vehicle 30c is a dedicated vehicle intended for stock replenishment, expendable product replenishment, energy replenishment, or the like to cause the store vehicle 30 to function for product sales or labor service that is provided by the store vehicle 30. Hereinafter, with respect to the store vehicle 30, the vehicle 30c that is a dedicated vehicle intended for various replenishments described above is simply referred to as a “replenishment vehicle 30c”. Replenishment targets for the store vehicle 30 are loaded on the replenishment vehicle 30c. Typically, the replenishment targets are products that are handled by the store vehicle 30. The products include consumer products such as paper towels, paper cups, and drinking water for providing labor service. In addition, the replenishment targets include expendable products needing to be replaced due to a life, such as external vehicle lights, internal vehicle lights, indicator lights, batteries, and wipers that are used for the interior or exterior constituting the store vehicle 30. Further, the replenishment targets include energy such as power, gaseous fuel, or liquid fuel for driving the store vehicle 30. The replenishment vehicle 30c may be a dedicated vehicle intended for solely replenishment of stock of products or the like, a dedicated vehicle intended for solely replenishment of expendable products, or a dedicated vehicle intended for solely replenishment of energy such as power.

The replenishment vehicle 30c, for example, transports and replenishes a replenishment target to the store vehicle 30 while moving within a predetermined region from a predetermined replenishment base. The replenishment vehicle 30c moves along a predetermined route based on the operation command transmitted from the center server 10 cooperating with the replenishment management server 20 as will be described below and joins the store vehicle 30 needing replenishment. The replenishment management terminal 36 is mounted in the store vehicle 30, as in the replenishment vehicle 30c. Further, the replenishment vehicle 30c does not necessarily need to be unmanned. For example, a replenishment person or the like handling a replenishment target loaded on the replenishment vehicle 30c may get on the replenishment vehicle 30c. Further, the replenishment vehicle 30c may not necessarily a vehicle that performs autonomous traveling always. For example, the replenishment vehicle 30c may be a vehicle on which the person performs driving or assistance in driving according to situations. The moving body system to which the replenishment management system 1 according to the embodiment is applied includes a plurality of replenishment vehicles 30c. The replenishment vehicle 30c is an example of a “replenishment moving body” and is an example of “a dedicated moving body functioning for replenishment purpose”.

The replenishment management system 1 according to the embodiment includes the replenishment vehicle 30c and the replenishment management server 20. In the replenishment management system 1 according to the embodiment, the replenishment management server 20 manages, for example, stock information of products that are handled by the store vehicle 30. The replenishment management server 20 acquires, from the store vehicle 30, a stock situation of the products, a use state of expendable products, and an energy state together with positional information of the store vehicle. These various states are acquired via the replenishment management terminal 36 mounted in the store vehicle 30. In a case where the replenishment management server 20 determines that the stock situation of the product of the store vehicle 30 indicates shortage, the replenishment management server 20 searches for the replenishment vehicle 30c moving near the store vehicle 30 or the replenishment vehicle 30c waiting at a predetermined base and instructs the replenishment vehicle 30c that has been searched for to replenish the store vehicle 30 with the products. Similarly, when the replenishment management server 20 determines that the use state of expendable products of the store vehicle 30 exceeds a predetermined period, the replenishment management server 20 searches for the replenishment vehicle 30c moving near the store vehicle 30 or the replenishment vehicle 30c waiting at a predetermined base and instructs the replenishment vehicle 30c to replenish the store vehicle 30 with the expendable products. Further, when the replenishment management server 20 determines that the energy state of the store vehicle 30 becomes tight (below a predetermined amount), the replenishment management server 20 searches for the replenishment vehicle 30c moving near the store vehicle 30 or the replenishment vehicle 30c waiting at a predetermined base and instructs the replenishment vehicle 30c to replenish the store vehicle 30 with energy. Various replenishment instructions to the replenishment vehicle 30c are performed via the center server 10. In a case where the replenislunent management server 20 determines that the stock situation of the product of the store vehicle 30 indicates shortage, replenishment management server 20 may transmit the positional information of the store vehicle 30 to the replenishment vehicles 30c. In this case, each replenishment vehicle 30c determines whether or not a position is of the replenishment vehicle 30c is near the store vehicle 30 and transmits a determination result to the replenishment management server 20. Accordingly, the replenishment management server 20 can ascertain the replenishment vehicle 30c located near the store vehicle 30. That is, “searching for a vehicle” may include causing the replenishment vehicle 30c to determine whether or not the replenishment vehicle 30c can perform the replenishment for the store vehicle 30 and transmit a determination result to the replenishment management server 20.

The center server 10 cooperates with the replenishment management server 20 to instruct the store vehicle 30 and the replenishment vehicle 30c to operate for replenishment. For example, when the center server 10 receives an instruction to instruct the replenishment vehicle 30c to replenish the store vehicle 30a with product or the like from the replenishment management server 20, the center server 10 acquires the positional information and the moving route of the store vehicle 30a and specifies a point (a destination) at which replenishment by the replenishment vehicle 30c on the moving route is possible. The center server 10 transmits an operation command to “move from a current place to a destination point” to the replenishment vehicle 30c and the store vehicle 30a. Accordingly, the center server 10 can cause the replenishment vehicle 30c and the store vehicle 30a to travel along the predetermined route from the current place to the destination point and join each other. A command to command the store vehicle 30a and the replenishment vehicle 30c to provide a predetermined service to a user is included in the operation command, in addition to a command to command traveling from a departure place (a current place) to the destination. As an example, when a display is included on an exterior of the store vehicle 30a, an instruction to display, for example, an advertisement regarding product sales or labor service that is provided by the store vehicle 30a on the display may be issued through an operation command. Further, when an illumination or the like for warning a user is included on the exterior of the store vehicle 30a, the store vehicle 30a that is moving may be caused to perform lighting or blinking of the illumination for urging to warn the user. Further, in the replenishment vehicle 30c including a display on the exterior thereof, an indication indicating that replenishment being performed may be displayed on the display according to the operation command.

Further, when the replenishment is performed on the store vehicle 30a, the replenishment management server 20 may select another store vehicle 30b capable of replenishing the store vehicle 30a with product or the like, and instruct the selected store vehicle 30b to replenish the store vehicle 30a. For example, when the replenishment management server 20 determines that the stock situation of the product of the store vehicle 30a indicates shortage, the replenishment management server 20 searches for and specifies the store vehicle 30b moving near the store vehicle 30a and being capable of replenishing the store vehicles 30a with the product or the like. “Searching for and specifying the store vehicle 30b” may include causing each store vehicle to determine whether or not the store vehicle can replenish the store vehicle 30a of which the stock has been determined to be short and to transmit a result of the determination to the replenishment management server 20. The replenishment management server 20 instructs the store vehicle 30b to replenish the store vehicle 30a of which the stock situation has been determined to indicate shortage with the product or the like. With the replenishment management server 20, it is possible for the replenishment vehicle 30c or the store vehicle 30b to rapidly replenish the store vehicle 30a with the products being short. The same applies a case where the replenishment targets are expendable products or energy. Hereinafter, products, expendable products, and energy that are replenishment targets are collectively referred to simply as “replenishment target”. The other store vehicle 30b capable of replenishing the store vehicle 30a with product or the like is an example of a “replenishment moving body”.

The replenishment management server 20, for example, notifies the center server 10 of a replenishment instruction to instruct the store vehicle 30b to replenish the store vehicle 30a with product or the like. After the center server 10 acquires the positional information and the moving routes of the store vehicle 30a and the store vehicle 30b, the center server 10 specifies a point (a destination) on the moving route of the store vehicle 30a at which the replenishment can be performed by the store vehicle 30b. The center server 10 transmits an operation command to command “the store vehicle 30a and the store vehicle 30b to move from the current place to the destination point”. The center server 10 can cause the store vehicle 30a and the store vehicle 30b to travel along a predetermined route from the current place to the destination point and join each other, as in the replenishment vehicle 30c described above.

According to the replenishment management system 1 of the embodiment, the replenishment of the replenishment targets is performed by the replenishment vehicle 30c or the store vehicle 30b. Thus, it is possible to suppress occurrence of shortage product or the like in the store vehicle 30a in which shortage has occurred in the stock situation of the product or the like as much as possible. As a result, in the replenishment management system 1 according to the embodiment, continuity of a service that is provided by the vehicle 30 functioning as a store can be secured.

2. Functional Configuration

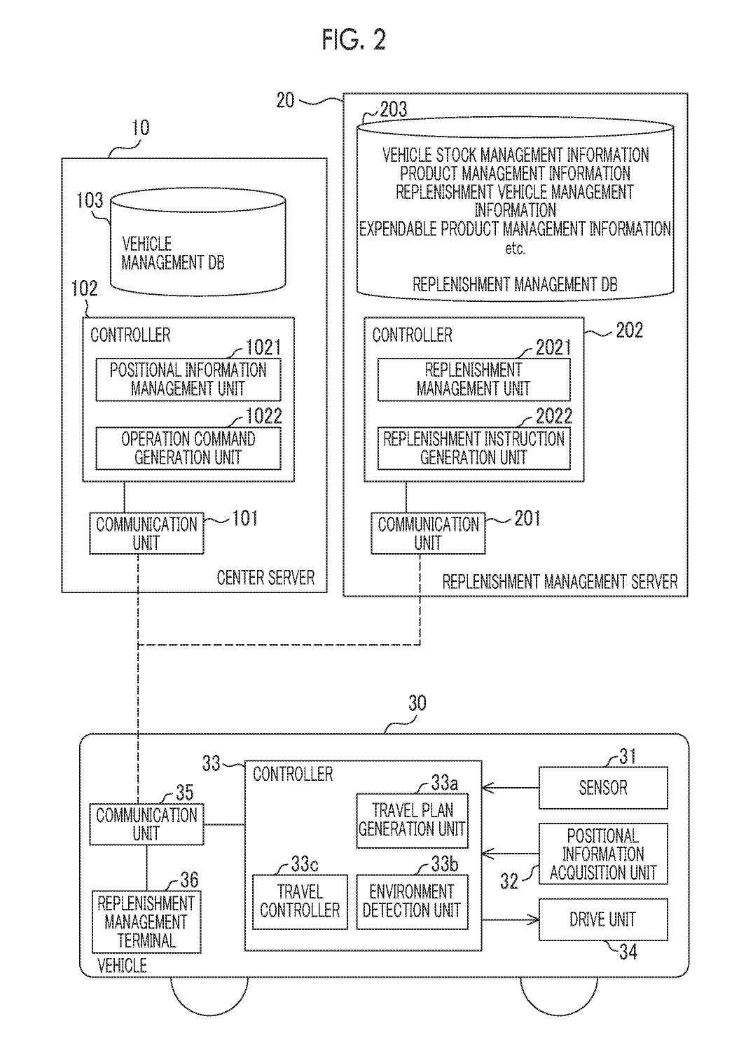

FIG. 2 is a block diagram illustrating a schematic configuration of the vehicle 30, the center server 10, and the replenishment management server 20 illustrated in FIG. 1. A hardware configuration and a functional configuration of the vehicle 30, the center server 10, and the replenishment management server 20 will be described with reference to FIG. 2. It is assumed that the vehicle 30 functions as the store vehicles 30a, 30b and a replenishment vehicle 30c. A configuration of the vehicle 30 functioning as the store vehicles 30a, 30b is the same as that of the vehicle 30 functioning as the replenishment vehicle 30c.

The vehicle 30 is a vehicle traveling according to the operation command acquired from the center server 10. Specifically, the vehicle 30 generates the travel route based on the operation command acquired via the network N, and travels on the road using an appropriate method as autonomous travel while sensing the surroundings of the vehicle 30. The vehicle 30 includes a sensor 31, a positional information acquisition unit 32, a controller 33, a drive unit 34, a communication unit 35, and a replenishment management terminal 36. The vehicle 30 operates, for example, with power that is supplied from a battery (not illustrated).

The sensor 31 is means for sensing surroundings of the vehicle 30 in order to acquire information needed for autonomous travel of the vehicle 30, and typically includes a stereo camera, a visible light camera, a laser scanner, a light detection and ranging or laser imaging detection and ranging (LIDAR), a radar, and the like. Information acquired by the sensor 31 is transmitted to the controller 33 and used by the controller 33 for recognition of obstacles or traveling lanes present around the vehicle 30. The positional information acquisition unit 32 is means for acquiring a current position of the vehicle 30, and typically includes a OPS receiver or the like. The information acquired by the positional information acquisition unit 32 is transmitted to the controller 33 and is used for a predetermined process such as calculation of a route for the vehicle to reach the destination using the current position of the vehicle 30, for example. Further, the information acquired by the positional information acquisition unit 32 is transmitted to the center server 10 and the replenishment management server 20 connected to the network N via the communication unit 35 regularly or in response to a request from each server.

The controller 33 is a computer that controls the vehicle 30 based on information acquired from the sensor 31 or the positional information acquisition unit 32. The controller 33, for example, is configured of a microcomputer, and causes a central processing unit (CPU; not illustrated) to execute a program stored in storage means (a read only memory (ROM) or the like; not illustrated), thereby realizing a function for performing the various processes described above. As a specific example of the various processes, the controller 33 includes functional modules such as an operation plan generation unit 33a, an environment detection unit 33b, and a travel controller 33c.

The operation plan generation unit 33a acquires an operation command from the center server 10 and generates an operation plan of the subject vehicle. The operation command includes information on a departure place and a destination instructed to the vehicle 30. Therefore, the operation plan generation unit 33a calculates the route along which the vehicle 30 is to travel, based on the destination given from the center server 10 and the position of the subject vehicle obtained by the positional information acquisition unit 32, and generates the operation plan. The operation plan includes data on the route along which the vehicle 30 travels, which has been calculated in this way, and data for defining a process to be performed by the vehicle 30 in a part or all of the route. Examples of data included in the operation plan include the following (1) and (2).

(1) Data Indicating Route Along which Subject Vehicle Travels Using Set of Road Links

The route along which the subject vehicle travels, for example, may be automatically generated based on the instructed departure place and destination by referring to map data stored in storage means (not illustrated). The calculation of the route along which the subject vehicle travels may depend on a process of an external device (for example, the center server 10), not within the vehicle 30. In this case, the center server 10 may acquire a subject vehicle position from the vehicle 30, calculate a route along which the vehicle 30 is to travel, and cause the calculated route data to be included in the operation command, or may separately transmit the operation command to the vehicle 30.

(2) Data Indicating Process to be Performed by Subject Vehicle at Point on Route

Examples of a process to be performed by the subject vehicle include “to temporarily stop by”, “to receive replenishment of a product”, “to receive replenishment of an expendable product”, and “to receive replenishment of energy”, but is not limited thereto. For example, in the vehicle 30 functioning as the replenishment vehicle 30c, examples of the process can include “to temporarily stop by,” “to replenish a product,” “to replenish an expendable product”, and “to replenish energy”. The operation plan generated by the operation plan generation unit 33a is transmitted to the travel controller 33c to be described below.

The environment detection unit 33b detects a surrounding environment of the vehicle 30 needed for autonomous traveling based on the data acquired by the sensor 31. Examples of detection targets include the number or position of lanes, the number or position of vehicles around the subject vehicle, the number or position of obstacles (for example, pedestrians, bicycles, structures, or buildings) around the subject vehicle, structures of roads, and road signs, but the detection targets are not limited thereto. The detection targets can be any targets as long as the targets are needed for autonomous traveling. For example, in a case where the sensor 31 is a stereo camera, objects around the vehicle 30 are detected performed by performing image processing on image data captured by the stereo camera to image processing. Further, the environment detection unit 33b may not only detect the objects around the vehicle 30, but also track the detected objects (continuously detect a detected target). For example, a relative speed of the object can be obtained from a difference between coordinates of the object detected one step before and coordinates of a current object. Data regarding the surrounding environment of the vehicle 30 (hereinafter, environment data) detected by the environment detection unit 33b is transmitted to the travel controller 33c to be described below.

The travel controller 33c controls generates a control command for controlling autonomous traveling of the subject vehicle based on the operation plan generated by the operation plan generation unit 33a, the environment data generated by the environment detection unit 33b, and the positional information of the subject vehicle acquired by the positional information acquisition unit 32. For example, the travel controller 33c generates a control command to cause the subject vehicle to travel along a predetermined route and cause the subject vehicle to travel so that an obstacle does not enter a predetermined safety region around the subject vehicle. The generated control command is transmitted to the drive unit 34 to be described below. A known method can be adopted as a method of generating a control command for causing the vehicle to autonomously travel.

The drive unit 34 is means for causing the vehicle 30 to travel based on the control command generated by the travel controller 33c. The drive unit 34 includes, for example, a motor, an inverter, a brake, and a steering mechanism for driving wheels. The motor, the brake, or the like is driven according to a control command, thereby realizing autonomous travel of the vehicle 30. Further, the communication unit 35 is communication n means for connecting the vehicle 30 to the network N. In the embodiment, the communication unit 35 can perform communication with another device (for example, the center server 10 or the replenishment management server 20) using a mobile communication service such as 3rd Generation (3G) or long term evolution (LTE) via the network N.

The replenishment management terminal 36 is a computer for managing the stock situation of the replenishment targets for the vehicle 30 to function as the store vehicles 30a, 30b or the replenishment vehicle 30c. The replenishment management terminal 36 has, for example, a configuration of a general computer including a processor (not illustrated) such as a CPU, a main storage device (not illustrated) such as a ROM or a random access memory (RAM), and an auxiliary storage device (not illustrated) such as an erasable programmable ROM (EPROM), a hard disk drive (HDD), or a removable medium. Further, the replenishment management terminal 36 may include an input device such as a mouse or a keyboard, an output device such as a display, and a touch panel display serving as an input device and an output device.

The replenishment targets that are managed by the replenishment management terminal 36 include products that are handled by the store vehicle 30, expendable products needing to be replaced due to service life such as internal vehicle lights or external vehicle lights for an interior or exterior constituting the store vehicle 30, indicator lights, batteries, and wipers, and energy such as power for driving the store vehicle 30. In addition, products that are handled by the store vehicle 30 include not only products as finished products but also materials for constituting the finished products. For example, in a case where pizza or the like is cooked and sold, various foodstuffs such as pizza dough, cheese or tomato for topping, and ham constituting the pizza are included in the replenishment targets. The replenishment management terminal 36 is configured not to be involved in autonomous traveling of the vehicle 30 in principle. Therefore, the replenishment management terminal 36 is configured not to act on the controller 33 in principle. However, the replenishment management terminal 36 is configured to be able to communicate with the replenishment management server 20 via the communication unit 35.

The replenishment management terminal 36, for example, acquires the stock situation of the products that are handled by the store vehicle 30 via a point of sales (POS) terminal (not illustrated) connected to an in-vehicle network (a local Interconnect network (LIN), a controller area network (CAN), or a LAN) constructed in the vehicle. In the case of an unmanned store vehicle 30 having a vending machine or the like, for example, the stock situation is acquired through an RFID reader terminal (not illustrated) capable of reading information on a radio frequency identifier (RFID) tag or an IC tag attached to a product, which is connected to the replenishment management terminal 36 via the in-vehicle network. Similarly, a stock situation of various foodstuffs constituting products as finished products is acquired through reading of RFID tags or IC tags attached to predetermined quantity units (for example, bag units or box units). Further, the replenishment management terminal 36 acquires an energy use situation (remaining amount of energy) of the store vehicle 30 such as a state of charge (SOC) via an electronic control unit (ECU) connected to the in-vehicle network. The replenishment management terminal 36 acquires information indicating the situation of the replenishment target described above at predetermined cycle intervals and outputs the acquired information to the communication unit 35.

The replenishment targets include consumer products such as paper cups, paper towels, drinking water, and fuel gas, which are consumed when product sales or labor service is provided. The replenishment management terminal 36, for example, ascertains a consumption quantity of the paper cups, the paper towels, and the like by reading RFID tags or IC tags attached to a predetermined quantity unit (for example, one box containing 100 pieces). Further, the replenishment management terminal 36, for example, ascertains a consumption situation of the drinking water, the fuel gas, and the like through, for example, a sensor that detects the remaining amount of the drinking water, the fuel gas, and the like or a sensor that detects a weight of a tank in which the drinking water, the fuel gas, and the like are enclosed.

Next, the center server 10 will be described. The center server 10 is a device that manages autonomous traveling of a plurality of vehicles 30 constituting the moving body system and transmits an operation command to each vehicle. The center server 10 cooperates with the replenishment management server 20 to generate operation commands on stock replenishment, expendable product replenishment, and energy replenishment to the store vehicle 30a needing replenishment of replenishment targets, and the replenishment vehicle 30c or the store vehicle 30b capable of stock replenishment to the store vehicle 30a. The center server 10 is configured of a general computer including a processor (not illustrated) such as a CPU or a digital signal processor (DSP), a main storage device (not illustrated) such as a RAM or a ROM, and an auxiliary storage device (not illustrated) such as an EPROM, a hard disk drive, or a removable medium. The removable medium includes a disc recording medium such as a universal serial bus (USB) memory, a compact disc (CD), or a digital versatile disc (DVD). In addition, the center server¹⁰ may include an input device such as a mouse or a keyboard, and an output device such as a display or a printer. However, the center server 10 may be a single computer or may be a system including a group of a plurality of computers, such as a cloud. The center server 10 reads an operating system (OS), various programs, various tables, and the like stored in the auxiliary storage device to a work area of the main storage device and executes the operating system, programs, tables, and the like. The center server 10 realizes a function according to a predetermined purpose by controlling each component or the like through execution of a program.

The center server 10 includes a communication unit 101, a controller 102, and a vehicle management database (DB) 103 constructed in an auxiliary storage device. The communication unit 101 is a communication interface with the network N. Examples of a communication IF include a LAN interface board, and a wireless communication circuit for wireless communication.

The controller 102 has an information processing function that is provided by the processor executing the program. An information processing function of managing autonomous travel of the vehicles 30 constituting the moving body system and transmitting an operation command to each vehicle is provided by the controller 102. The controller 102 includes at least a positional information management unit 1021 and an operation command generation unit 1022. A series of processes that are executed by the center server 10 can be executed by hardware, but can also be executed by software.

The positional information management unit 1021 collects the positional information (for example, latitude and longitude) from the vehicles 30 and manages the positional information under the management of the center server 10. In the embodiment, the positional information management unit 1021 receives positional information at a current point in time transmitted from the store vehicles 30a, 30b and the replenishment vehicle 30c at predetermined cycle intervals, and stores the received positional information in the vehicle management DB 103.

The operation command generation unit 1022 receives a replenishment notification from the cooperative replenishment management server 20 and generates an operation command for the corresponding store vehicles 30a, 30b and the replenishment vehicle 30c. The replenishment notification from the replenishment management server 20 includes information on the store vehicle 30a that is a replenishment target, the replenishment vehicle 30c that supplies the replenishment targets to the store vehicle 30a, or the store vehicle 30b capable of supplying the replenishment targets to the store vehicle 30a. The operation command generation unit 1022 acquires the positional information of the store vehicle 30a, the replenishment vehicle 30c, or the store vehicle 30b at the current point in time. The operation command generation unit 1022 sets each vehicle position at a current point in time as a departure place and specifies a joining point (a destination) at which replenishment can be performed by the replenishment vehicle 30c or the store vehicle 30b by referring to the map data stored in the auxiliary storage device. The joining point may be, for example, a point on the moving route of the store vehicle 30a or may be a point at which the store vehicle 30a, the replenishment vehicle 30c, or the store vehicle 30b can be parked or stopped for replenishment in a region in which the store vehicle 30a provides product sales or labor service. The operation command generation unit 1022 generates an operation command to cause each vehicle 30 to operate from the vehicle position at a current point in time to the joining point. The operation command includes an instruction for receiving the supply of the replenishment targets at the joining point, an instruction for supplying the replenishment targets, and the like.

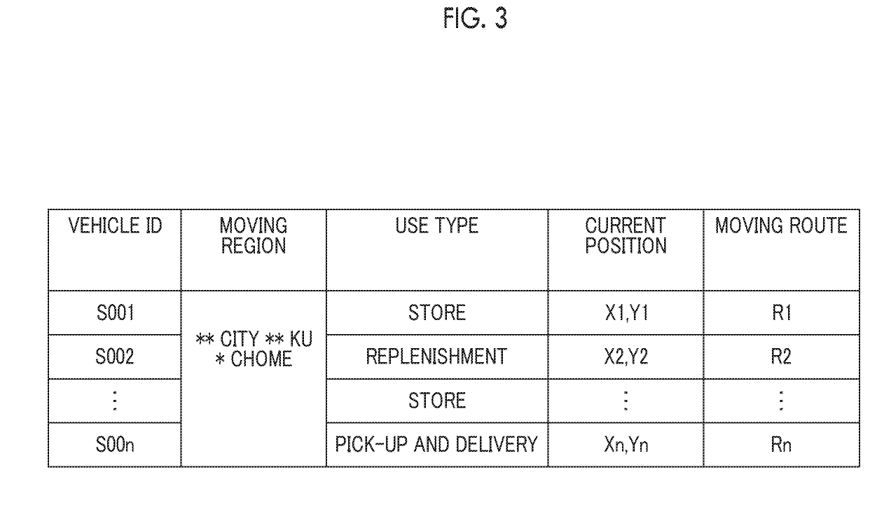

Vehicle management information on the vehicles 30 performing autonomous traveling is stored in the vehicle management DB 103. FIG. 3 is a diagram illustrating vehicle management information having a table structure. As illustrated in FIG. 3, the vehicle management information includes fields such as a vehicle ID, a moving region, a use type, a current position, and a moving route. Identification information for uniquely identifying the vehicle 30 that is managed by the center server 10 is stored in the vehicle ID. Information for specifying a region where each vehicle provides a service is stored in the moving region. The moving region may be information indicating a municipality or the like or may be information for specifying a region partitioned by latitude and longitude. In the use type, information for specifying a use type of the service that is provided by each vehicle is stored. “Store” is stored in the store vehicles 30a, 30b, and “replenishment” is stored in the replenishment vehicle 30c. The positional information (latitude and longitude) acquired via the positional information acquisition unit 32 of each vehicle 30 is stored in the current position. The positional information is updated when the positional information transmitted from each vehicle 30 is received. Information on the travel route of each vehicle in the moving region (for example, a number for designating data according to a set of road links) is stored in the moving route.

Next, the replenishment management server 20 will be described. The replenishment management server 20 is a computer that manages replenishment targets such as products that are handled by store vehicles. Since the replenishment management server 20 is a general computer having the same configuration as the center server 10, description thereof will be omitted. The replenishment management server 20 may be configured of a single computer or may be a system configured by a group of a plurality of computers, such as a cloud. The replenishment management server 20 reads an OS, various programs, various tables, and the like stored in the auxiliary storage device to the work area of the main storage device, executes the OS, programs, tables, and the like, and controls each component or the like through the execution of the program, thereby realizing a function according to a predetermined purpose.

The replenishment management server 20 includes a communication unit 201, a controller 202, and a replenishment management DB 203 constructed in the auxiliary storage device. Since the communication unit 201 is the same as the communication unit 101, description thereof will be omitted. The replenishment management server 20 acquires the positional information of the store vehicles 30a, 30b and the replenishment vehicle 30c connected to the network N via the communication unit 201. The positional information of each vehicle is specified by the positional information acquisition unit 32. In addition, the replenishment management server 20 acquires a situation of the replenishment targets of the store vehicles 30a, 30b and the replenishment vehicle 30c connected to the network N via the communication unit 201. The situation of the replenishment target is managed by the replenishment management terminal 36 mounted in the store vehicles 30a, 30b and the replenishment vehicle 30c. Further, the replenishment management server 20 notifies the cooperating center server 10 of the replenishment instruction to instruct the replenishment vehicle 30c or the store vehicle 30b to replenish the store vehicle 30a needing replenishment via the communication unit 201.

The controller 202 has an information processing function that is provided by the processor of the replenishment management server 20 executing a program. An information processing function of managing a situation of the replenishment target of the store vehicle 30 and instructing the replenishment vehicle 30c or the store vehicle 30b capable of replenishing the replenishment target to perform replenishment when the shortage of the replenishment target is detected is provided by the controller 202. The controller 202 includes at least a replenishment management unit 2021 and a replenishment instruction generation unit 2022. A series of processes that are executed by the replenishment management server 20 can be executed by hardware, but can also be executed by software.

The replenishment management unit 2021 collects the positional information from the store vehicles 30a, 30b functioning as stores and the replenishment vehicle 30c among the vehicles 30 constituting the moving body system, and manages the positional information. The replenishment management unit 2021 acquires the positional information at a current point in time transmitted from the store vehicles 30a, 30b and the replenishment vehicle 30c at predetermined cycle intervals and stores the acquired positional information of each vehicle in the vehicle stock management information of the replenishment management DB 203. Similarly, the replenishment management unit 2021 collects various situations (stock situation, stock situation of consumer products such as paper cups, energy state (remaining amount of energy)) of the replenishment targets at a current point in time from the store vehicles 30a, 30b and the replenishment vehicle 30c and manages the situations. The replenishment management unit 2021 acquires various situations of the replenishment targets at a current point in time transmitted from the store vehicles 30a, 30b and the replenishment vehicle 30c at predetermined cycle intervals, and stores the acquired situations of the respective vehicles in the vehicle stock management information of the replenishment management DB 203.

The replenishment instruction generation unit 2022 determines the shortage of the product of the store vehicle based on the stock situation or the like acquired from the store vehicle 30. Similarly, the replenishment instruction generation unit 2022 determines that the energy state of the store vehicle is tight (a predetermined value or less) from the use state of the energy acquired from the store vehicle 30. Further, the replenishment instruction generation unit 2022 determines a life of expendable products constituting the store vehicle 30. The determination of the replenishment instruction generation unit 2022 is performed by referring to the replenishment management DB 203.

For example, when the replenishment instruction generation unit 2022 determines shortage of the product stock of the store vehicle 30a, the replenishment instruction generation unit 2022 searches for the replenishment vehicle 30c that is moving near the store vehicle 30a or the replenishment vehicle 30c that is waiting at a predetermined point. Further, the replenishment instruction generation unit 2022 searches for another store vehicle 30b that is moving near the store vehicle 30a and is capable of supplying products to the store vehicle 30a. The replenishment instruction generation unit 2022 generates an instruction to instruct the replenishment vehicle 30c or the store vehicle 30b that has been searched for to replenish the products to the store vehicle 30a. The generated replenishment instruction includes information on the store vehicle 30a that is a replenishment target, the replenishment vehicle 30c that supplies products being short to the store vehicle 30a, or the store vehicle 30b capable of supplying products being short to the store vehicle 30a. The replenishment management server 20 notifies the cooperating center server 10 of the replenishment instruction generated by the replenishment instruction generation unit 2022. Similarly, the replenishment vehicle 30c or the store vehicle 30b is searched for in a case where the replenishment targets are expendable products and the energy. An instruction to instruct the replenishment vehicle 30c or the store vehicle 30b that has been searched for to replenish the store vehicle 30a with the replenishment target is generated.

Next, the replenishment management DB 203 will be described. At least the vehicle stock management information, the product management information, the replenishment vehicle management information, and the expendable product management information are stored in the replenishment management DB 203.

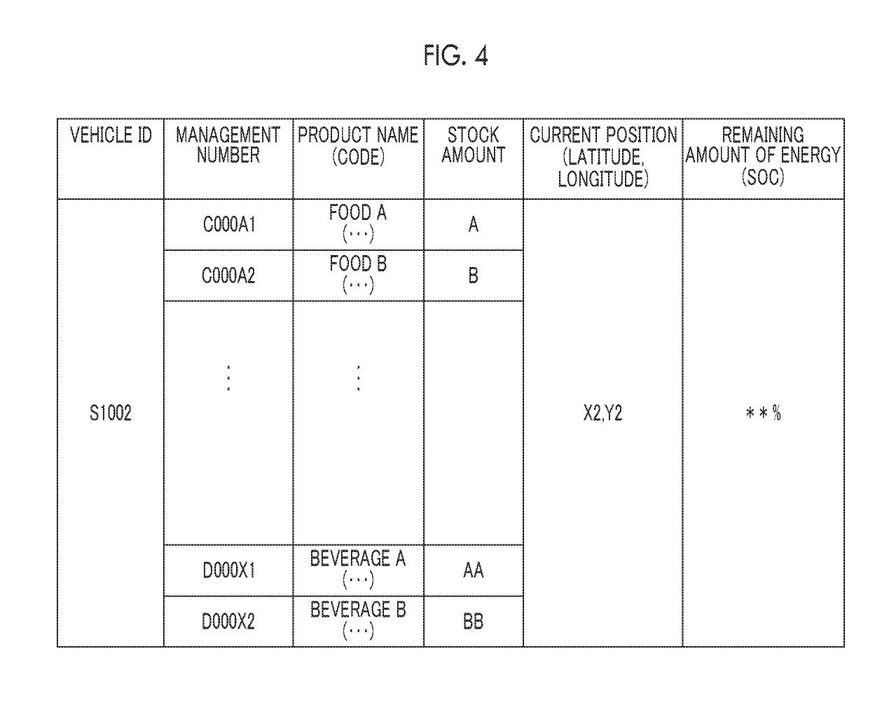

The vehicle stock management information is information for managing a stock situation of consumer products such as products or paper cups that are handled by the store vehicle 30 that is providing a service, and a stock situation of the replenishment vehicle 30c that loads the replenishment targets. The vehicle stock management information is managed for each store vehicle 30 and for each replenishment vehicle 30c. FIG. 4 is a diagram illustrating vehicle stock management information having a table structure. As illustrated in FIG. 4, the vehicle stock management information includes fields such as a vehicle ID, a management number, a product name, stock amount, a current position, and an energy state. The vehicle ID is identification information for uniquely identifying the vehicle 30 that is managed by the center server 10. The management number is a management number of a product or a consumer product that is a replenishment target. The product name is a name of the product or the consumer product that is a replenishment target. A product code such as a Japanese Article Number (JAN) code or a European Article Number (EAN) code is stored in the product name together with the above product name. The stock quantity is a stock quantity of consumer products such as products or paper cups handled by the store vehicle 30 or the replenishment target in the replenishment vehicle 30c. The stock quantity indicates a stock situation of the product or the like acquired from the replenishment management terminal 36. The current position is positional information (latitude and longitude) transmitted from the store vehicle 30 or the replenishment vehicle 30c. The energy state is a state of use of energy for driving the store vehicle 30 or the replenishment vehicle 30c. Information to be stored in the energy state is acquired from the replenishment management terminal 36. In the example of FIG. 4, an example of the energy state includes an SOC indicating a state of charge of a battery transmitted from the replenishment management terminal 36. The positional information is updated when the positional information transmitted from each store vehicle 30 and the replenishment vehicle 30c is received. The same applies to the stock quantity and the energy state.

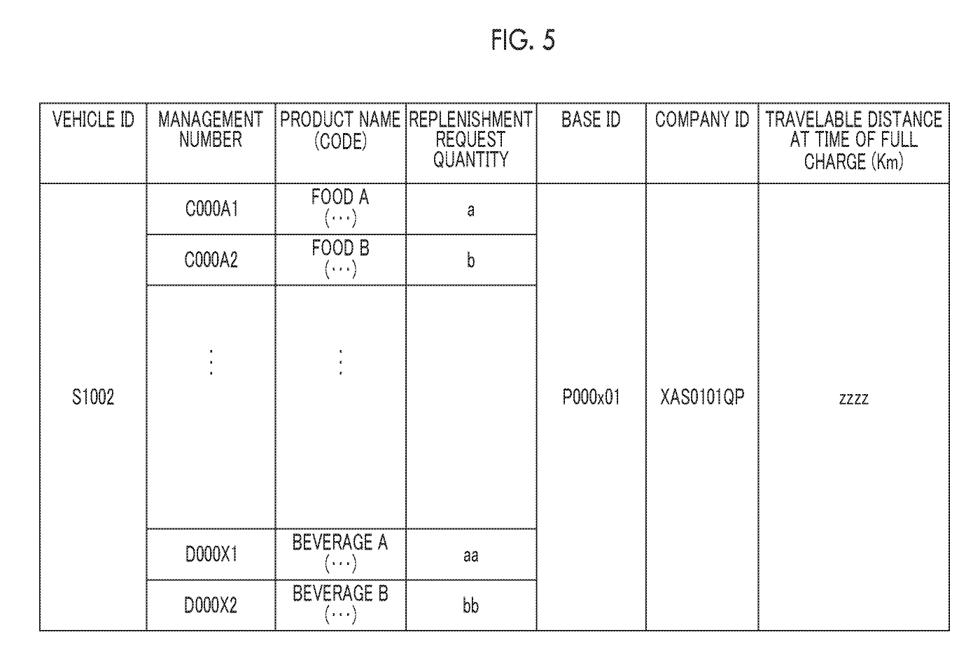

The product management information is information for managing products that are handled by the store vehicle 30, consumer products such as paper cups, or the like. The product management information is managed for each store vehicle 30. FIG. 5 is a diagram illustrating product management information having a table structure. As illustrated in FIG. 5, the product management information includes fields such as a vehicle ID, a management number, a product name, a replenishment request quantity, a base ID, a company ID, and a travelable distance at the time of full charge. Since the vehicle ID, the management number, and the product name are the same as the vehicle stock management information illustrated in FIG. 4, description thereof will be omitted. The replenishment request quantity is information for determining shortage in stock for the product or expendable product. The base ID is identification information for identifying a place serving as a base of the store vehicle 30. The store vehicle 30 departs from a base place identified by the base ID and returns to the base place after service provision for the moving region is completed. The company ID is identification information for uniquely identifying a company that provides product sales or labor service using the store vehicle 30. In the company ID, a company code assigned to the company, or the like is stored. The travelable distance at the time of full charge is a distance by which the store vehicle 30 can travel when a battery for driving the store vehicle 30, or the like is fully charged.

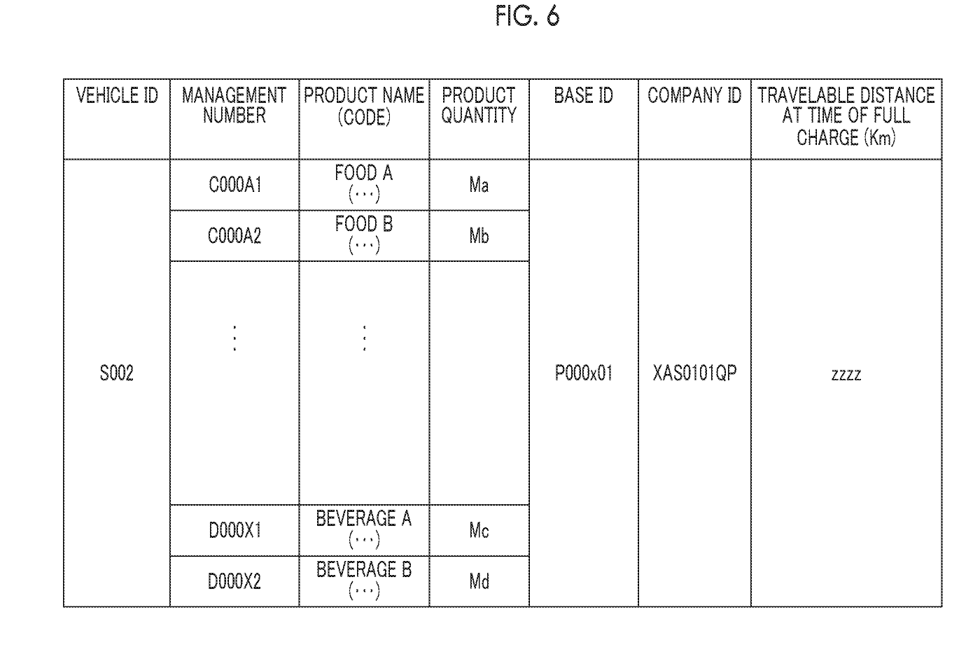

The replenishment vehicle management information is information for managing the replenishment targets of the replenishment vehicle 30c. The replenishment vehicle management information is managed for each replenishment vehicle 30c. FIG. 6 is a diagram illustrating the replenishment vehicle management information having a table structure. FIG. 6 is an example of the replenishment vehicle management information on the replenishment vehicle 30c that supplies consumer products such as products or paper cups handled by the store vehicle 30 as replenishment targets. As illustrated in FIG. 6, the replenishment vehicle management information includes fields such as a vehicle ID, a management number, a product name, a product quantity, a base ID, a company ID, and a travelable distance at full charge. Since the vehicle ID, the management number, and the product name are the same as the vehicle stock management information illustrated in FIG. 4, description thereof will be omitted. In addition, since the base ID, the company ID, and the travelable distance at the time of full charge are the same as the product management information illustrated in FIG. 5, description thereof will be omitted. The product quantity indicates a quantity that can be replenished by the replenishment vehicle 30c at the time of departure from the base place identified using the base ID.

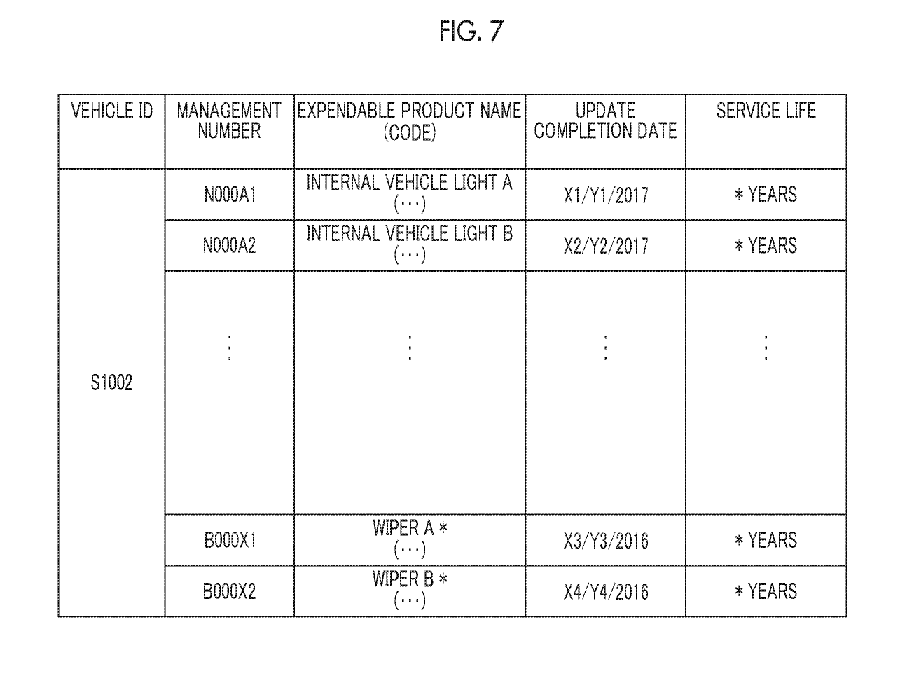

The expendable product management information is information for managing expendable products constituting the interior or exterior of the store vehicle 30. In the expendable product management information, products needing replacement due to a life are mainly managed. The expendable product management information is managed for each store vehicle 30. FIG. 7 is a diagram illustrating expendable product management information having a table structure. As illustrated in FIG. 7, expendable product management information includes fields such as a vehicle ID, a management number, an expendable product name, an update completion date, and a service life. Since the vehicle ID and the management number are the same as the vehicle stock management information illustrated in FIG. 4, description thereof will be omitted. The expendable product name is a name of an expendable product that is a replenishment target. In the expendable product name, a product code such as a JAN code or an EAN code of the expendable product is stored together with a name of the expendable product. The update completion date is the latest date on which replacement of the expendable product has been completed for the store vehicle 30. The service life is a service life that is defined in a specification of the expendable product. The service life is adopted as a criterion for determining the life of the expendable product.

3. Process Flow

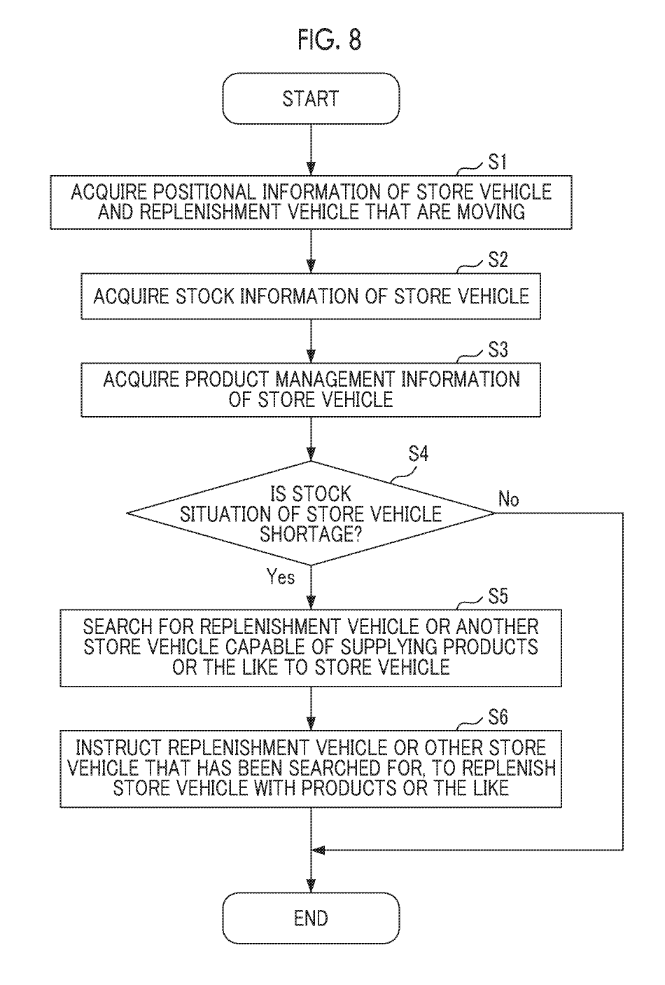

Next, a process regarding replenishment instruction generation of the replenishment management server 20 according to the embodiment will be described with reference to FIGS. 8 to 10. FIG. 8 is a flowchart illustrating an example of a replenishment instruction generation process in a case where a product or the like to be provided by the store vehicle 30 is a replenishment target.

In the flowchart of FIG. 8, the process is started, for example, when the store vehicles 30a, 30b and the replenishment vehicle 30c are connected to the replenishment management server 20 via the network N. Each vehicle, for example, provides a service of each vehicle 30 while moving along a predetermined moving route in a moving region stored in the vehicle management DB 103. Each vehicle connected to the network N transmits, for example, the positional information of the subject vehicle acquired via the positional information acquisition unit 32 to the center server 10 and the replenishment management server 20. Further, each vehicle transmits, for example, stock information of the subject vehicle acquired through the replenishment management terminal 36 to the replenishment management server 20. A vehicle ID for uniquely identifying each vehicle is added to the positional information and the stock information that are transmitted from each vehicle.

The replenishment management server 20 acquires the positional information transmitted from the store vehicles 30a, 30b and the replenishment vehicle 30c (S1). The positional information of each vehicle is acquired at predetermined cycle intervals. The replenishment management server 20 stores the acquired positional information of each vehicle in the replenishment management DB 203. The positional information acquired from each vehicle is stored in a current position field of the vehicle stock management information corresponding to each vehicle ID. The process of S1 that is executed by the replenishment management server 20 may be regarded as an example of “means for acquiring positional information of one or more moving bodies”.

Further, the replenishment management server 20 acquires the stock information transmitted from the store vehicles 30a, 30b (S2). Similarly, the replenishment management server 20 acquires stock information transmitted from the replenishment vehicle 30c. The stock information of each vehicle is acquired at predetermined cycle intervals. The replenishment management server 20 stores the acquired stock information of each vehicle in the replenishment management DB 203. The stock information acquired from each vehicle is stored in a stock quantity field of the vehicle stock management information corresponding to each vehicle ID, similar to the positional information. Hereinafter, for description of the process, the store vehicle 30a is assumed to be a processing target of which a stock situation has been determined to indicate shortage.

The replenishment management server 20 acquires the product management information of the store vehicle 30a from which the stock information has been acquired in the process of S2 by referring to the replenishment management DB 203 (S3). The replenishment management server 20, for example, searches for the product management information using the vehicle ID added to the stock information as a search key, and extracts the product management information of the store vehicle 30a corresponding to the vehicle ID. The extracted product management information is temporarily stored in a predetermined region of the main storage device.

The replenishment management server 20 determines shortage of the stock situation of the store vehicle 30a based on the stock information of the store vehicle 30a acquired in the process of S2 and the product management information of the store vehicle 30a acquired in the process of S3 (S4). The replenishment management server 20, for example, acquires a quantity of “food A” stored in a replenishment request quantity field of the product management information. The replenishment management server 20 compares the acquired replenishment request quantity of “Food A” with the stock quantity of “Food A” included in the stock information. When a stock quantity of “food A” is equal to or smaller than the replenishment request quantity, the replenishment management server 20 determines that “food A” is short. The replenishment management server 20 repeats the same process for each product and determines the shortage of the stock situation of the store vehicle 30a. Since the stock situation determined to indicate the shortage includes expendable materials such as paper towels or drinking water, consumer products, including products that are sales targets and consumer products are referred to as a “product or the like”.

When the replenishment management server 20 determines that the stock situation of the product or the like of the store vehicle 30a indicates shortage (“Yes” in S4), the replenishment management server 20 proceeds to a process of S5. On the other hand, when the replenishment management server 20 determines that the stock situation of the product or the like of the store vehicle 30a indicates no shortage (“No” in S4), the replenishment management server 20 ends the process of FIG. 8. Here, the process of S2 that is executed by the replenishment management server 20 can be said to be a process of acquiring the stock information of the product from “a store moving body functioning as a store among one or more moving bodies”. Further, since the replenishment management server 20 determines the shortage of the stock situation of the product or the like of the store vehicle 30a in the processes of S3 and S4, the process can be said to be a process of detecting “the shortage of a stock situation” of the store vehicle 30a. In other words, the processes of S2 to S4 that are executed by the replenishment management server 20 may be regarded as an example of “means for detecting shortage of a stock situation of a product that is provided by a store moving body functioning as a store among one or more moving bodies from the store moving body”.

In the process of S5, the replenishment management server 20 searches for a replenishment vehicle capable of supplying product or the like of which shortage has occurred in the store vehicle 30a, or another store vehicle. The replenishment management server 20, for example, searches for a replenishment vehicle located around the store vehicle 30a based on a relative distance between the positional information of the store vehicle 30a acquired in the process of S1 and the positional information of the replenishment vehicle. The replenishment management server 20, for example, searches for replenishment vehicle present in a range of a unit distance such as 1 km, 3 km, or the like with the store vehicle 30a as a center position. Alternatively, the replenishment management server 20 may search for the vehicle stock management information stored in the replenishment management DB 203 using the product or the like of which the shortage has occurred as a search key and specify a replenishment vehicle capable of replenishing the product or the like. Further, the replenishment management server 20 may specify the replenishment vehicle waiting at a predetermined base designated by the base ID. Similarly, the search of the replenishment vehicle described above is applied to other store vehicles. When a plurality of replenishment vehicles and a plurality of store vehicles are specified as a result of the search, the replenishment management server 20 may determine a priority based on a relative distance up to the store vehicle 30a and a stock quantity of the product or the like of which the shortage has occurred. As a result of the search, the replenishment vehicle 30c and the store vehicle 30b capable of supplying product or the like of which shortage has occurred in the store vehicle 30a are specified. After the process of S5, the process proceeds to S6. Here, the process of SS5 that is executed by the replenishment management server 20 may be regarded as an example of “means for searching for a replenishment moving body being able to supply the product that is provided by the store moving body from among one or more moving bodies.” Further, the selection of the store vehicle 30b based on the positional information of the store vehicles 30a, 30b and the replenishment vehicle 30c may be regarded as an example of “management means for selecting a store moving body instructing supply of a product based on the positional information of the store moving body and the replenishment moving body”.

In the process of S6, the replenishment management server 20 generates an instruction to instruct the replenishment vehicle 30c or the other store vehicle 30b that has been searched for, to replenish the store vehicle 30a with the product or the like. The replenishment management server 20, for example, acquires the vehicle ID of the specified replenishment vehicle 30c. In addition, the replenishment management server 20 acquires a product code of a product or the like of which the shortage has occurred. The replenishment management server 20, for example, associates an instruction to “replenish a product code **” with the vehicle ID of the replenishment vehicle 30c and an instruction to “receive replenishment of the product code **” with the vehicle ID of the store vehicle 30a, and generates a replenishment instruction. Similarly, a replenishment instruction is generated for the store vehicle 30b. The generated replenishment instruction is transmitted to the center server 10 cooperating with the replenishment management server 20. After the process of S6, the process of FIG. 8 ends. Here, the process of S6 that is executed by the replenishment management server 20 can be said to be a process of “instructing the replenishment moving body that has been searched for to supply products to the store moving body”. Since a case where the replenishment management server 20 determines that the stock situation of the product or the like of the store vehicle 30a indicates shortage in the process of S4 is an example of “when shortage of the stock situation of the product that is provided by the store moving body has been detected”, the process of S6 that is executed by the replenishment management server 20 can be said to be an example of “management means for instructing the replenishment moving body that has been searched for to supply the product to the store moving body when the shortage of the stock situation of the product that is provided by the store moving body is detected”.

Through the above process, in the replenishment management system 1 according to the embodiment, it is possible for the replenishment vehicle 30c or the store vehicle 30b to replenish the store vehicle 30a of which the stock situation is determined to be shortage with the product or the like. Further, in the replenishment management system 1 according to the embodiment, it is possible to select the store vehicle 30b closest to the store vehicle 30a of which the stock situation is determined to be shortage based on the positional information acquired from each vehicle. Therefore, since the store vehicle 30a can be rapidly replenished with the replenishment target from the store vehicle 30b closest to the store vehicle, the continuity of service can be maintained.

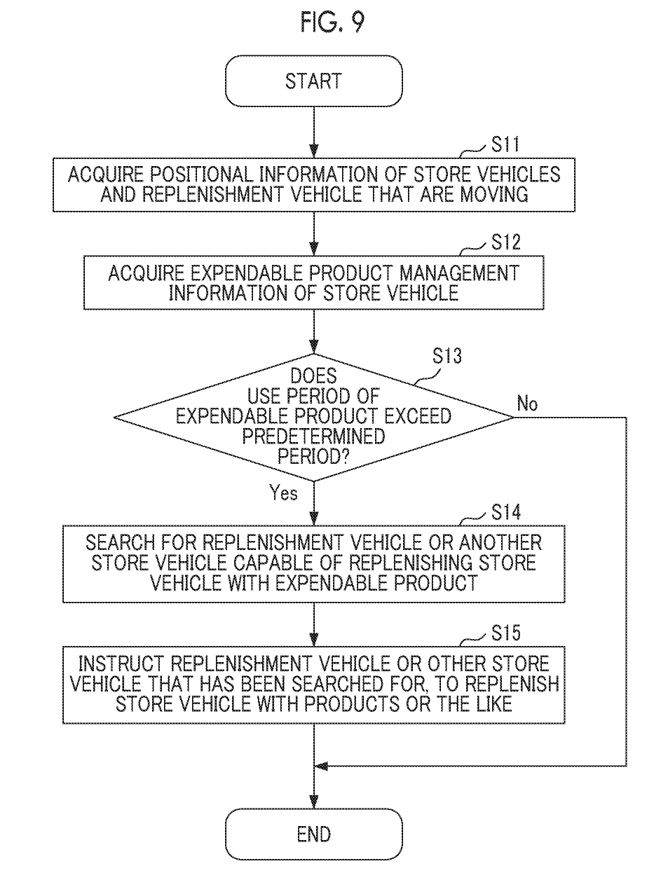

Next, FIG. 9 will be described. FIG. 9 is a flowchart illustrating an example of a replenishment instruction generation process in a case where expendable products constituting the store vehicle 30 are replenishment targets. Since the start of the process in the flowchart of FIG. 9 is the same as that in FIG. 8, description thereof will be omitted. In addition, in the flowchart of FIG. 9, since a process of S11 corresponds to the process of S1 and processes of S14 to S15 correspond to the processes of S5 and S6, description thereof will be omitted. Hereinafter, processes of S12 and S13 will be mainly described.

In the process of S12, the replenishment management server 20 acquires the expendable product management information of the store vehicle 30a from which the positional information has been acquired in the process of S11 by referring to the replenishment management DB 203. Search using the vehicle ID of the store vehicle 30a as a search key is performed and the expendable product management information of the store vehicle 30a corresponding to the vehicle ID is extracted. The extracted expendable product management information is temporarily stored in a predetermined region of the main storage device.

In the process of S13, the replenishment management server 20 determines whether or not the use period of the expendable product exceeds a predetermined period based on the expendable product management information of the store vehicle 30a extracted in the process of S12. The replenishment management server 20, for example, acquires date information stored in an update completion date field of “internal vehicle light A” of the expendable product management information, and service life stored in a service life field. The replenishment management server 20 specifies a use period from the update completion date to the current point in time, and compares the use period with the service life. When the use period exceeds the service life, the replenishment management server 20 determines that the use period of the expendable product exceeds the predetermined period. The replenishment management server 20 repeats the same process for each expendable product and determines the service life of each expendable product constituting the store vehicle 30a. Since a life is assumed to end (failure of a bulb or the like) even when the use period is shorter than the service life, when the replenishment management server 20 may multiply a service life by a margin rate for a determination. The margin rate can also be held for each category of the expendable product. The replenishment management server 20 can suppress failure of the expendable product constituting the store vehicle 30a in advance by adopting the margin rate at the time of a determination of the life of the expendable product. In the process of S13, the predetermined period used for a determination of the use period of the expendable product is an example of a “first threshold value”.

When the replenishment management server 20 determines that the use period of the expendable product exceeds the predetermined period (“Yes” in S13), the replenishment management server 20 proceeds to the process of S14. On the other hand, when the replenishment management server 20 determines that the use period of the expendable product of the store vehicle 30a does not exceed the predetermined period (“No” in S13), the replenishment management server 20 ends the process of FIG. 9. In processes of S14 and S15, the replenishment vehicle 30c or the store vehicle 30b capable of replenishing the store vehicle 30a with the expendable products is specified, and a replenishment instruction in which product codes of the expendable products are associated with the respective vehicle IDs is generated. The store vehicle 30b specified in the processes of S14 and S15 is, for example, a store vehicle in which expendable products are treated as products.

In the replenishment management system 1 according to the embodiment, through the above process, the store vehicle 30a in which the use period of the expendable product is determined to exceed the predetermined period can be replenished with the expendable product by the replenishment vehicle 30c or the store vehicle 30b. With the replenishment management system 1 according to the embodiment, it is possible to suppress service stop due to failure of the expendable product in advance.

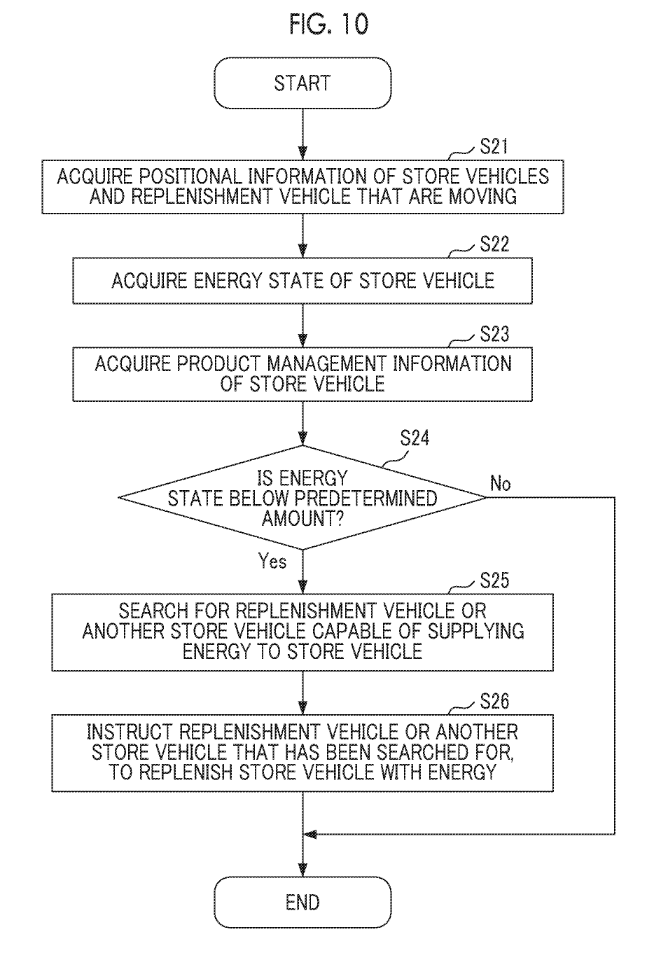

Next, FIG. 10 will be described. FIG. 10 is a flowchart illustrating an example of the replenishment instruction generation process in a case where energy such as power for driving the store vehicle 30 is a replenishment target. Since start of the process in the flowchart of FIG. 10 is also the same as in FIG. 8, description thereof will be omitted. In addition, in the flowchart of FIG. 10, since a process of S21 corresponds to the process of S1, and processes of S25 and S26 correspond to the process of S5 and S6, description thereof will be omitted. Hereinafter, processes of S22 to S24 will be mainly described.

In the process of S22, the replenishment management server 20 acquires information indicating the energy state transmitted from the store vehicles 30a, 30b. Information indicating the energy state transmitted from the replenishment vehicle 30c is also acquired. The information indicating the energy state of each vehicle is acquired at predetermined cycle intervals. The replenishment management server 20 stores the acquired information (the remaining amount of charge: SOC) indicating the energy state of each vehicle in the replenishment management DB 203. The information indicating the energy state acquired from each vehicle is stored in an energy state field of the vehicle stock management information corresponding to each vehicle ID.

In the process of S23, the replenishment management server 20 acquires the product management information of the store vehicle 30a for which the information indicating the energy state has been acquired in the process of S22 by referring to the replenishment management DB 203. The acquisition of the product management information is performed similarly to the process of S3. The replenishment management server 20 temporarily stores the extracted product management information in a predetermined region of the main storage device.

In the process of S24, the replenishment management server 20 determines whether or not the energy state of the store vehicle 30a is below a predetermined amount based on the information indicating the energy state of the store vehicle 30a acquired in the process of S22 and the product management information of the store vehicle 30a acquired in the process of S23. The replenishment management server 20, for example, acquires information (a distance value) stored in a field of a travelable distance at the time of full charge of the product management information. The replenishment management server 20 specifies a travelable distance of the store vehicle 30a at a current point in time based on a relationship between the acquired distance value and the information indicating the energy state. The replenishment management server 20 specifies a distance from the positional information acquired in the process of S21 and the positional information indicated by the base ID of the product management information to the base. The replenishment management server 20 determines that an energy state of the store vehicle 30a is below the predetermined amount when the travelable distance according to the energy state at a current point in time is below a distance from the current position to the base. Since there is concern that traveling of the vehicle is disabled even when the travelable distance according to the energy state at the current point in time exceeds the distance from the current position to the base, the replenishment management server 20 may multiply the travelable distance by the margin rate for a determination. By adopting the margin rate, the replenishment management server 20 can suppress traveling being disabled due to exhaustion of energy. Further, the replenishment management server 20 may set a threshold value for the acquired information indicating the energy state (remaining amount of energy), and determine that the energy state of the store vehicle 30a is below the predetermined amount when the energy state is equal to or smaller than the threshold value (for example, SOC 30%). In the process of S24, the predetermined amount used for a determination as to the energy state is an example of a “second threshold value”.

When the replenishment management server 20 determines that the energy state of the store vehicle 30a is below the predetermined amount (“Yes” in S24), the replenishment management server 20 proceeds to the process of S25. On the other hand, when the replenishment management server 20 determines that the energy state of the store vehicle 30a is not below the predetermined amount (“No” in S24), the replenishment management server 20 ends the process of FIG. 10. In the processes of S25 and S26, the replenishment vehicle 30c or the store vehicle 30b capable of replenishing the store vehicle 30a with energy is specified, and an energy supply instruction associated with the respective vehicle IDs (the store vehicle 30a, the replenishment vehicle 30c, or the store vehicle 30b) is generated.

Through the above process, in the replenishment management system 1 according to the embodiment, it is possible for the replenishment vehicle 30c or the store vehicle 30b to replenish the store vehicle 30a of which the energy state is determined to be below the predetermined amount with energy. With the replenishment management system 1 according to the embodiment, it is possible to suppress service stop due to exhaustion of energy.

Computer-Readable Recording Medium

A program for causing an information processing device, another machine, or a device (hereinafter, a computer or the like) to realize any of the above functions can be recorded on a recording medium that is readable by a computer or the like. By causing the computer or the like to read and execute the program in the recording medium, it is possible to provide the function.

Here, a recording medium that is readable by a computer or the like refers to a recording medium capable of accumulating information such as data or programs using an electrical, magnetic, optical, mechanical, or chemical action, which can be read from the computer or the like. Examples of a recording medium that can be detached from the computer or the like among such recording media include a flexible disk, a magneto-optical disk, a compact disc-read only memory (CD-ROM), a compact disc-rewritable (CD-R/W), a DVD, a Blu-ray disc, a digital audio tape (DAT), an 8 mm tape, and a memory card such as a flash memory. Further, examples of a recording medium fixed to the computer or the like include a hard disk and a ROM.

What is claimed is:

1. An information system comprising circuitry configured to
detect, from a store moving body configured to function as a store among a plurality of moving bodies, a shortage of a stock situation of a replenishment target that is supplied to the store moving body,
select a replenishment moving body being able to supply the replenishment target to the store moving body from among the moving bodies, and
instruct the selected replenishment moving body to supply the replenishment target to the store moving body when the shortage of the stock situation of the replenishment target at the store moving body is detected.

2. The information system according to claim 1, wherein
the replenishment moving body is at least one of the other store moving body among the moving bodies and a dedicated moving body, the dedicated moving body being configured to function for a purpose of replenishment of the replenishment target for which the shortage of the stock situation is detected.

3. The information system according to claim 1, further comprising a communication unit configured to communicate with the store moving body via a network,
wherein the circuitry is configured to receive at least one of information from a point of sales terminal acquired at the store moving body, tag information imparted to the replenishment target, information from a sensor that detects an amount of consumption of the replenishment target, and information from a sensor that detects a remaining amount of the replenishment target via the communication unit, and detect the shortage of the stock situation.

4. The information system according to claim 1, wherein:
the replenishment target is an expendable product constituting the store moving body; and
the circuitry is configured to manage a use period of the expendable product and instruct the replenishment moving body to supply the expendable product to the store moving body when the use period of the expendable product exceeds a first threshold value.

5. The information system according to claim 1, wherein:
the replenishment target acts as a supply unit configured to supply energy for causing the store moving body to function; and
the circuitry is configured to manage a saving state of the energy for causing the store moving body to function, and instruct the replenishment moving body to replenish the store moving body with the energy via the replenishment target acting as the supply unit when the saving state of the energy falls below a second threshold value needed for causing the store moving body to function.

6. The information system according to claim 1, wherein:
the circuitry is configured to acquire positional information of the moving bodies; and
the circuitry is configured to select the replenishment moving body instructed to supply the replenishment target based on positional information of the store moving body and the replenishment moving body.

7. The information system according to claim 1, wherein
the circuitry is configured to determine a joining point of the store moving body and the replenishment moving body from any one of a point on a moving route of the store moving body or the replenishment moving body, and a point at which parking and stopping are possible within a region in which the store moving body provides a product sales or a service, with positions at a current point in time of the store moving body and the replenishment moving body being respective departure places.

8. An information processing method executable by a computer, the information processing method comprising:
(a) detecting, from a store moving body configured to function as a store among a plurality of moving bodies, a shortage of a stock situation of a replenishment target that is supplied to the store moving body;
(b) selecting, from among the moving bodies, a replenishment moving body being able to supply the replenishment target to the store moving body, and
(c) instructing the selected replenishment moving body to supply the replenishment target to the store moving body when the shortage of the stock situation of the replenishment target at the store moving body is detected.

9. The information processing method according to claim 8, wherein
the replenishment moving body is at least one of the other store moving body among the moving bodies and a dedicated moving body, the dedicated moving body being configured to function for a purpose of replenishment of the replenishment target for which the shortage of the stock situation is detected.

10. The information processing method according to claim 8, wherein
the step of (a) includes receiving at least one of information from a point of sales terminal acquired at the store moving body, tag information imparted to the replenishment target, information from a sensor that detects an amount of consumption of the replenishment target, and information from a sensor that detects a remaining amount of the replenishment target, and detecting the shortage of the replenishment target to be supplied to the store moving body.

11. The information processing method according to claim 8, wherein:
the replenishment target is an expendable product constituting the store moving body; and
the step of (c) includes managing a use period of the expendable product and instructing the replenishment moving body to supply the expendable product to the store moving body when the use period of the expendable product exceeds a first threshold value.

12. The information processing method according to claim 8, wherein:
the replenishment target acts as a supply unit configured to supply energy for causing the store moving body to function; and
the step of (c) includes managing a saving state of the energy for causing the store moving body to function, and instructing the replenishment moving body to supply the energy to the store moving body via the replenishment target acting as the supply unit, when the saving state of the energy falls below a second threshold value needed for causing the store moving body to function.

13. The information processing method according to claim 8, further comprising
(d) acquiring positional information of the moving bodies,
wherein the step of (b) includes selecting a replenishment moving body instructed to supply the replenishment target based on the positional information of the store moving body and the replenishment moving body.

14. The information processing method according to claim 8, further comprising
(e) determining a joining point of the store moving body and the replenishment moving body from any one of a point on a moving route of the store moving body or the replenishment moving body, and a point at which parking and stopping are possible within a region in which the store moving body provides a product sales or a service, with positions at a current point in time of the store moving body and the replenishment moving body being respective departure places.

15. A non-transitory storage medium recording a program, the program causing a computer to execute
detecting, from a store moving body configured to function as a store among a plurality of moving bodies, a shortage of a stock situation of a replenishment target that is supplied to the store moving body,
selecting a replenishment moving body being able to supply the replenishment target to the store moving body from among the moving bodies, and
instructing the selected replenishment moving body to supply the replenishment target to the store moving body when the shortage of the stock situation of the replenishment target at the store moving body is detected.
